(19) United States
(12) Patent Application Publication
(10) Pub. No.: US 2021/0329745 A1
(43) Pub. Date: Oct. 21, 2021

(54) HEATING ELEMENT AND METHOD OF USE

(71) Applicant: TUTCO, LLC, Cookeville, TN (US)

(72) Inventor: James Patrick LOLLAR, Cookeville, TN (US)

(21) Appl. No.: 17/231,188

(22) Filed: Apr. 15, 2021

Related U.S. Application Data
(60) Provisional application No. 63/010,922, filed on Apr. 16, 2020.

(51) Int. Cl. H05B 3/36

(52) U.S. Cl. CPC H05B 3/36; H05B 2203/011; H05B 2203/003

(57) ABSTRACT

A heating element includes first and second terminals and one or more heating element segments extending between the first and second terminals. The one or more heating element segments have a circuit trace that includes at least first and second portions, the at least first and second portions configured so that a surface temperature difference exists between the at least first and second portions when a voltage is applied between the at least first and second terminals. The heating element can also be made with a three dimensional shape, including one that is generated by fastening of the heating element to one or more support plates. The heating element can also have a cylindrical shape and be disposed in an insulating medium in a tubular member to provide varied heating capability along the tubular member length.

This application claims priority under 35 USC 119(e) based on provisional application No. 63/010,922, filed on Apr. 16, 2020, which is herein incorporated in its entirety.

### FIELD OF THE INVENTION

A heating element with a zig-zag pattern is disclosed that includes a unique configuration that can be used in various heating applications.

### BACKGROUND OF THE INVENTION

In the field of heating elements, expanded type heating elements are well known. U.S. Pat. No. 3,789,417 to Bittner is one example of an expanded type heating element assembly that includes a zig-zag pattern of the heating element material, the pattern creating openings in the heating element material as well.

Other patterned heating elements are disclosed in U.S. Pat. No. 7,763,833 to Hindel et al., U.S. Pat. No. 7,211,772 to Carpino II et al., and Pre-Grant Publication No. 2007/0164015 to Carpino II et al., all of which assigned to Goodrich Corporation. For the most part, the patterned heating elements of the Goodrich patents are foil sheets that are primarily used for deicing applications.

While these heating elements offer flexibility to be used in different applications because of their thin gauge, improvements are still needed in heating element designs to offer more capability and flexibility for these types of elements to be used in different applications.

Another heating element is disclosed in Pre-Grant Publication No. 2019/0008322 to Feldman et al., which is incorporated in its entirety herein. This heating element is described with reference to FIGS. 1-4.

Referring now to FIGS. 1 and 2, one embodiment of a heating element is designated by the reference numeral 100 and includes terminals 101 (including terminals 101A and 101B). heating element segments 103 (including segments 103A-F), and buses 105 (including buses 105A-E). In the example depicted in FIGS. 1 and 2, the heating element 100 includes six heating element segments 103A-F connected together by five buses 105A-105B, but in other examples the heating element 100 may include more or fewer heating element segments 103. Other examples may include a quantity of heating element segments 103 that range from about 1 to about 20, or from about 2 to about 12. Some examples may have an even number of heating element segments 103 such as 2, 4, 6, 8, 10, or 12 etc.

The heating element 100 has a total width W2 and each heating element segment 103 has a width W1. The total width W2 is greater than the sum of the widths W1 of each heating element segment 103 in the heating element 100. In certain examples, the total width W2 of the heating element is about 35% to about 45% greater than the sum of the widths W1 of the one or more heating element segments. In certain examples, the total width W2 of the heating element 101 is in a range from about 2 inches to about 18 inches, or in a range from about 3 inches to about 12 inches, or in a range from about 4 inches to about 6 inches.

The heating element 100 includes terminals 101A and 101B arranged at opposite ends of the heating element 100. The terminals 101 are electrically conductive contact points that connect the heating element 100 to a power source or other heating elements. In this example, the terminals 101A and 101B are also each connected to at least one heating element segment 103 of the heating element 100. For example, terminal 101A is connected at one end of heating element segment 103A and terminal 103B is connected at one end of heating element segment 103F.

The heating element segments 103 may be connected in series so that the current path between the terminals 101A, 101B is increased as compared to a surface area having only a single heating element segment 103. For example, the current path is at least six times the length L1 of the first heating element segment 103A. By increasing the current path between the terminals 101A, 101B, higher voltages may be employed by the power source (e.g., 110V that may be the same as the voltage source to which the appliance is plugged into) and/or lower current, which may be helpful in avoiding use of a power converter or otherwise reduce the cost of components of a heating device that includes the heating element 100.

In the example shown in FIGS. 1 and 2, the heating element 100 has a total length L0 and a first set of outermost heating element segments (e.g., segments 103A and 103F) have a first length L1, a second set of inner heating element segments (e.g., segments 103B and 103E) have a second length L2, and a third set of innermost heating element segments (e.g., segments 103C and 103D) have a third length L3. In the example depicted in FIGS. 1 and 2, three sets of heating element segments are depicted, and each set includes two heating element segments. In other examples, a set of heating element segments may include a single heating element segment or may include more than two heating element segments, and the heating element 100 may include more than or fewer than three sets of heating element segments.

The length of each heating element segment 103 (e.g., L1, L2, or L3) is greater than the width W2 of each heating element segment 103. The ratio of the lengths L1, L2, L3 to the width W2 can be selected in order to obtain a desired power output, current flow, and resistance. In some examples, the heating element segments 103 each have a width W2 in a range from about 0.1 inches to about 6 inches, or in a range from about ¼ inch to about 1 inch. In some examples, the width W2 is about ½ inch. In some examples, the lengths L1-L3 of the heating element segments 103 may range from about 2 inches to about 12 inches, or may range from about 3 inches to about 8 inches. In certain examples, the length L1 of the first set of heating elements is about 70% to about 90% the length L3 of the third set of heating elements. In certain examples, the length L2 of the second set of heating elements is about 80% to about 99% the length L3 of the third set of heating elements.

In the heating element 100 depicted in FIGS. 1 and 2, the bus 105A which connects heating element segments 103A and 103B, has an elbow or bent shape for accommodating the different lengths L1, L2 between these heating element segments. The bus 105E which connects heating element segments 103E and 103F also has an elbow or bent shape for accommodating the different lengths L1, L2 between these heating element segments. Buses 105B, 105C, and 105D each have a straight or linear shape for connecting adjacent heating element segments (e.g., heating element segments 103B and 103C, heating element segments 103C and 103D, and heating element segments 103D and 103E). In certain examples, the shapes of the terminals 130 (e.g., terminals 101A-B) and the buses 105 (e.g., buses 105A-E) may vary.

The buses 105A-E and the terminals 101A, 101B each include one or more apertures 107 to provide mechanical contact points. In certain examples, electrically insulated mechanical supports are fastened to the apertures 107 to hold the terminals 101 and buses 105 in a desired position.

During operation, electricity can be supplied to the heating element 100 by electrically connecting the terminals 101A and 101B to the power source. As electricity flows through the heating element 100, the material of the heating element segments 103 begins to heat up and glow. Typically, the glowing begins at temperatures between about 500 and 550° C. (about 1,000 degrees° F.). When the heating element segments 103 glow, they generate and radiate infrared radiation. In some embodiments, the heating element segments 103 have a temperature in a range from about 800 to about 900° C. during operation, or about 850° C.

Referring now to FIG. 3, an enlarged view of the heating element 100 is depicted showing the heating element segment 103B extending between the bus 105A and the bus 105B. Each heating element segment 103A-F has a repeating pattern 109 formed from a plurality of cutouts 111. The cutouts 111 are spaced apart from one another in the repeating pattern 109, and are surrounded by rounded corners. In some examples, the repeating pattern 109 is formed of two columns of cutouts 111 and a nested third column of cutouts 111 that overlaps and/or is arranged between the first two columns of cutouts 111. The repeating pattern 109 may allow the heating element 100 to provide a uniform radiant heating.

Referring now to FIG. 4, the cutouts 111 have an elliptical shape such that they are substantially oval or circular. For example, each cutout 111 includes first and second walls 113a and 113b that are curved and that flare out in opposing directions along a vertical axis A-A. In this manner, each cutout 111 is separated along the vertical axis A-A from another cutout 111. Additionally, each cutout 111 is linked to an opposing wall 113a, 113b of an adjacent cutout 111. Each cutout 111 is symmetrical about both the vertical axis A-A and the horizontal axis B-B.

The curved shape of the cutouts 111 increases the current path between the terminals 101A, 101B of the heating element 100 so that higher voltages may be employed and/or a lower current may be used to heat the heating element 100. Additionally, the shape of the cutouts 111 provides a complex resistance path that may help reduce hot spots in the heating element 100.

As depicted in FIG. 4, the cutouts 111 may each have an individual width W5 and an individual length L5. In certain examples, the width W5 may range from about 0.20 inches to about 0.35 inches, and the length L5 may range from about 0.06 inches to about 0.16 inches.

Referring back to FIGS. 1-4, in certain examples, the heating element 100 is a single sheet of material such that the terminals 101 (including terminals 101A and 101B), heating element segments 103 (including segments 103A-F), and buses 105 (including buses 105A-E) are all continuous with one another. Accordingly, separate elements or pieces are not used for connecting the terminals 101, heating element segments 103, and buses 105 since they are all part of the same continuous sheet of material. In certain examples, the heating element 100 is a single sheet of iron-chrome-aluminum alloy or similar alloy material. In other examples, the heating element 100 is a single sheet of an alloy of at least nickel and chromium, known as Nichrome.

To form the terminals 101, heating element segments 103, and buses 105 as a single piece of material, a blank sheet is cut from a roll of material and is then processed. In certain examples, the blank sheet is processed using photolithography to remove unwanted portions of the sheet through an etching process, leaving only the desired features of the heating element 100. In certain examples, the photolithography process includes the steps of applying a photoresist material onto a surface of the blank sheet, aligning a photomask having an inverse pattern to that of the desired heating element 100 with the sheet and the photoresist, exposing the photoresist to ultraviolet light through the photomask, and removing the portions of the photoresist exposed to ultraviolet light. Etching is then performed to remove those portions of the sheet of material that are not protected by the remaining photoresist. The remaining photoresist is then removed leaving the heating element 100 shown in FIGS. 1 and 2. In certain examples, the sheet of conductive material is etched from both sides simultaneously due to the sheet of material not being attached to a substrate during the photolithography process.

The photolithography process optimizes the structure of the heating element 100 by imparting a continuous and smooth transition between the terminals 101, heating element segments 103, and buses 105 which are all part of the same continuous sheet of material. This improves the current flow through the heating element 100 and accordingly, improves the performance of the heating element 100 so that the infrared radiation generated by heating element 100 reaches higher temperatures in less time.

In another possible example, other techniques such as machining and/or punching are done to process the blank sheet of material to form the terminals 101, heating element segments 103, and buses 105 as a continuous single sheet of material. For example, machining or cutting can be performed by a computer numerical control (CNC) router or similar machine.

By forming the terminals 101, heating element segments 103, and buses 105 all from a single sheet of material, the heating element 100 does not have any joints where two separate pieces of metal need to be fastened together. This is advantageous for several reasons. One benefit is that joints in a heating element are a potential source of failure because the joint can oxidize over time with the exposure to electricity and oxygen. Oxidation reduces the conductivity at that point, reducing the amount of current that can flow and creating a cold spot. Eliminating the joints therefore improves the operation and reduces the chance of undesirable oxidation occurring in the heating element 100. Another benefit is that the components (terminals, heating element segments, and buses) are all connected together to begin with, and therefore no manufacturing steps are required in order to connect these components together. Using the inventive heating element, one can easily design and build long or short circuits with simple or complex shapes and traces, without requiring one or multiple electrical and/or mechanical buss components and designs. These complex shapes can easily include heated circuit traces used to contour complex surfaces while maintaining control amounts of heat to specific areas. In addition, the lack of added fasteners not only can improve quality and potential life, but reduce costs and assembly labor. Traces can be folded while remaining intact without using fasteners requiring specific assembly sequences. Much like paper dolls, heaters can be specific to particular applications while ultimately remaining homogeneous.

After the blank sheet of conductive material has been processed, the finished heating element 100 may have a thickness T1 (depicted in FIG. 2). The thickness T1 can be selected for the heating element 100 to have a desired power output, current flow, and resistance. In certain examples, the thickness T1 is in a range from about ⅛ mm to about ⅜ mm, or about ¼ mm. In certain examples, the dimensions and material of the finished heating element 100 enable the heating element 100 to receive about 55V and to produce about 350 W+/−10% of energy. However, with the ability to easily change material alloy type and thickness, coupled with the ease of segment design, shape and spacing, it could easily be conceived to produce almost any practical voltage and wattage combination required. Given the many easy to configure and control design factors, the usage could be almost limitless in heating. Heaters for all manner of heating technologies, from convective or conductive type, to radiant heat technologies can be conceived and produced.

However, improvements are still needed with respect to heater elements like that shown in FIGS. 1-4 as their designs can cause manufacturing problems and are basically two dimensional by nature and have more limited applications as a result thereof. The present invention responds to this need by providing a number of different heating element designs.

### SUMMARY OF THE INVENTION

One object of the invention is to provide an improved heating element.

Another object of the invention is to provide a method of heating a space using the improved heating element.

In satisfaction of the objects and advantages associated with the invention, a first embodiment of the inventive heating element includes first and second terminals. The heating element also includes one or more heating element segments extending between the first and second terminals, each heating element segment having a plurality of cutouts arranged in a repeating pattern, each cutout having an elliptical or obround shape. The first and second terminals and the one or more heating element segments are a continuous single sheet of material.

In one embodiment, the heating segments can be divided into three sets. A first set of heating element segments has a first length, a second set of heating element segments has a second length, and a third set of heating element segments has a third length, the lengths of each set being the same.

The invention also includes a method of heating a space that includes providing the inventive heating element and supplying power to it to generate infrared radiation for space heating. This method of heating can use any of the inventive heating elements disclosed herein.

In one aspect of the invention, a heating element is provided that comprises first and second terminals and one or more heating element segments extending between the first and second terminals. Each heating element segment has a plurality of cutouts arranged in a repeating pattern, each cutout having an elliptical or obround shape. The first and second terminals and the one or more heating element segments are a continuous single sheet of material, and wherein at least one of the first and second terminals includes an extension part that can be folded with respect to the heating element. In another embodiment, each of the first and second terminals can include an extension part that is folded with respect to the heating element. The folding of the extension parts allows the heating element to stand alone in a given heating application or be used for mechanical attachment of the heating element to a desired structure or location.

The heating element can also comprise a plurality of heating element segments, the plurality of heating element segments extending in an arc. A set of the arc-shaped heating element segments can be provided to form a larger arc shape or a circular shape.

In yet another embodiment, the heating element is configured so that its surface temperature varies across the heating element so that a differential heating can be provided. In this embodiment, the heating element has at least first and second terminals and one or more heating element segments extending between the at least first and second terminals, the one or more heating element segments have a circuit trace that includes at least first and second portions, the at least first and second portions configured so that a surface temperature difference exists between the at least first and second portions when a voltage is applied between the at least first and second terminals.

The heating element providing a differential heating can be made with a three dimensional shape. The three dimensional shape can be any kind, including one of a semi-cylindrical shape, a cylindrical shape, and a sinusoidal shape.

The inventive heating element can be also be used in a tubular heater application. That is, the heating element can have a cylindrical shape and be disposed in an insulating medium for heating. The insulating medium can be further positioned between an inner pipe and an outer pipe for differential heating of material flowing through the inner pipe.

The heating element can be configured to having different power connections, for example, at least one power connection can be disposed between the at least first and second portions of a given circuit trace rather than at terminals of the heating element.

The heating element can also make use of separate jumper connections so that the heating element can be more simply designed and a plurality of more simply-shaped heating elements can be linked together using jumper connections.

For the differential heating aspect of the heating element, the circuit trace of the heating element can have difference configurations. For example, the circuit trace can have a plurality of first diamonds and a plurality of second diamonds, the plurality of first diamonds configured to have lower resistance that the plurality of second diamonds.

Alternatively, the circuit trace can have a plurality of diamonds, wherein a width of the plurality of diamonds continuously tapers between the at least first and second terminals or a width of the one or more of the plurality of diamonds varies along a length of the circuit trace.

The circuit trace can also have a plurality of diamonds, the diamonds having a strand width, and a width of a connection between at least one of the at least first and second terminals and a diamond adjacent to the at least one of the first and second terminals is larger than the strand width.

The circuit trace can also have at least a first set of diamonds having an electrical resistance and first shape and a second set of diamonds having said electrical resistance and a second shape different than the first shape and constituting less mass, the second set of diamonds running at a surface temperature higher than a surface temperature of the first set of diamonds when a voltage is applied to the circuit trace. The difference in shape can be based on one of a strand width of the diamonds of the circuit trace, a width of the diamonds, a number of diamonds in a set, an internal width or height spacing between strands forming a diamond.

Instead of forming the heating element with a three dimensional shape and using this three dimensional shape in a given heating application, the heating element can be formed into the three dimensional shape as part of forming the heater with a given support structure. In one embodiment, a heating element can be one that has or does not have differential heating capability described above. The heating element is provided with a first shape, e.g., a flat state, along with one or more support plates. When fastening of the portions of the heating element to the one or more support plates, the heating element is configured differently in shape from its original shape. For example, a two dimensional flat shape when attached to at least one support plate that has a different shape from the heating element, even if the difference is only in length, creates a three dimensional shape for the heating element. When using a flat shape for the heating element, having the heating element having a length longer than the length of the one or more support plates results in the heating element forming a three dimensional sinusoidal shape.

While one support plate can be used, a number of support plates can be used. In this embodiment, the portions of the heating elements can be attached to the support plates first and when the support plates are fit together, the three dimensional shape of the heating element is created.

### BRIEF DESCRIPTION OF THE DRAWINGS

FIG. 1 is a front plan view of a first embodiment of a prior art heating element.

FIG. 2 is an isometric view of the heating element shown in FIG. 1.

FIG. 3 is an enlarged view of the heating element shown in FIG. 1.

FIG. 4 is another enlarged view of the heating element shown in FIG. 1.

FIG. 5 shows a front plan view of one embodiment of an inventive heating element.

FIG. 6 shows another embodiment of the inventive heating element as a single segment.

FIG. 7 shows another single segment heating element with modified terminals.

FIG. 8 shows an enlarged drawing of the cutout of the heating element of FIG. 6.

FIG. 9 shows another embodiment of an inventive heating element in a fan shape.

FIGS. 10A and 10B show other heater element configurations using the heater element of FIG. 9.

FIGS. 11a-11d show different diamond strands that make up an inventive heater trace.

FIG. 12 shows an example of the inventive heating element or heater trace employing a number of strands.

FIGS. 13a and 13b show different sized heater traces.

FIGS. 14a and 14b shows different sized heater traces employing more than one trace.

FIG. 15 shows a heater trace using two different kinds of sub-traces.

FIG. 16 shows a heating element with multiple traces of different kinds.

FIG. 17 shows a conical-shaped heating element having multiple heater traces.

FIGS. 18a and 18b show heater traces with different kinds of terminal configurations.

FIGS. 19a-19e show examples of differently-shaped heater traces.

FIGS. 20a and 20b show heater traces with different strand shapes for different heating effects.

FIG. 21 shows a number of heater traces combined together with jumpers to form a heating element.

FIGS. 22a and 22b show a heater trace that can be designed for different heating depending on terminal connection to power.

FIGS. 23a and 23b show a two different heater trace designs, with a middle power connector(s).

FIGS. 24a-b show a heater trace in combination with a mica plate as a radiant heater assembly.

FIGS. 25a-c show a variation of a heater assembly using a pair of mica plates for conductive heating.

FIGS. 26a-b show another variation of a heater assembly using a heater trace and mica plate as a standup heater assembly.

FIGS. 27a-c show a variation on the standup heater assembly of FIG. 26.

FIGS. 28a-b show a heater trace formed into a three dimensional shape.

FIGS. 29a-b show a three dimensional heater trace as part of a heating element using insulation.

FIG. 30 shows another variation of a three dimensional heater trace formed to make a tubular-type heater.

FIGS. 31a-b show another three dimensional heater trace as part of a heater assembly, where the heater trace is pre-formed before heater assembling.

FIGS. 32a-32c show another embodiment of a heater trace and heater assembly, where the heater trace takes on a three dimensional shape when assembling the heater assembly.

FIG. 33a-33e show a variation of the heater assembly of FIGS. 32a-32c, wherein a plurality of mica plate supports are used when assembling the heater assembly.

FIGS. 34a-34e is yet another embodiment of a heater assembly wherein the heater trace is formed into a three dimensional shape as part of the heater assembling.

### DETAILED DESCRIPTION OF THE INVENTION

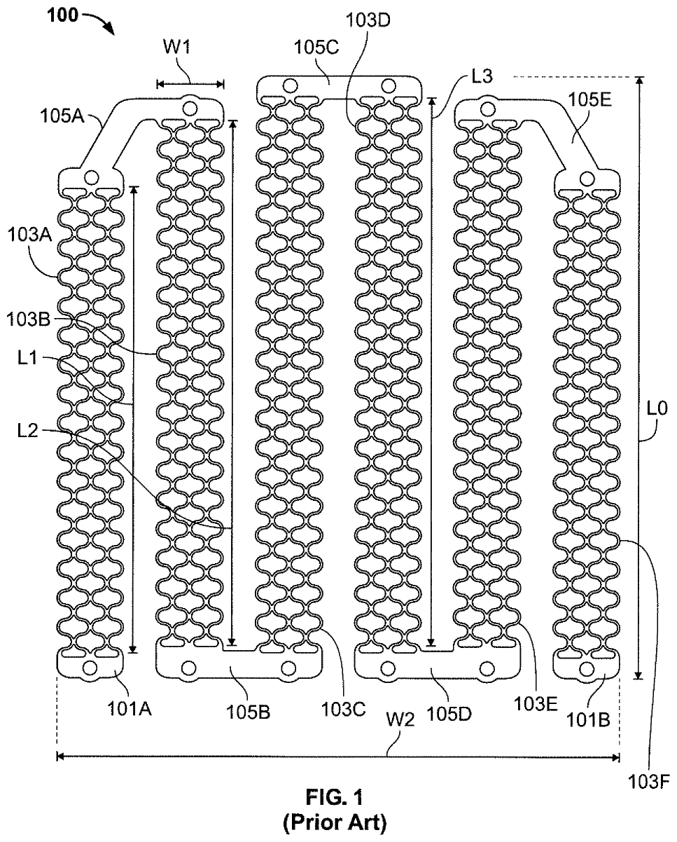

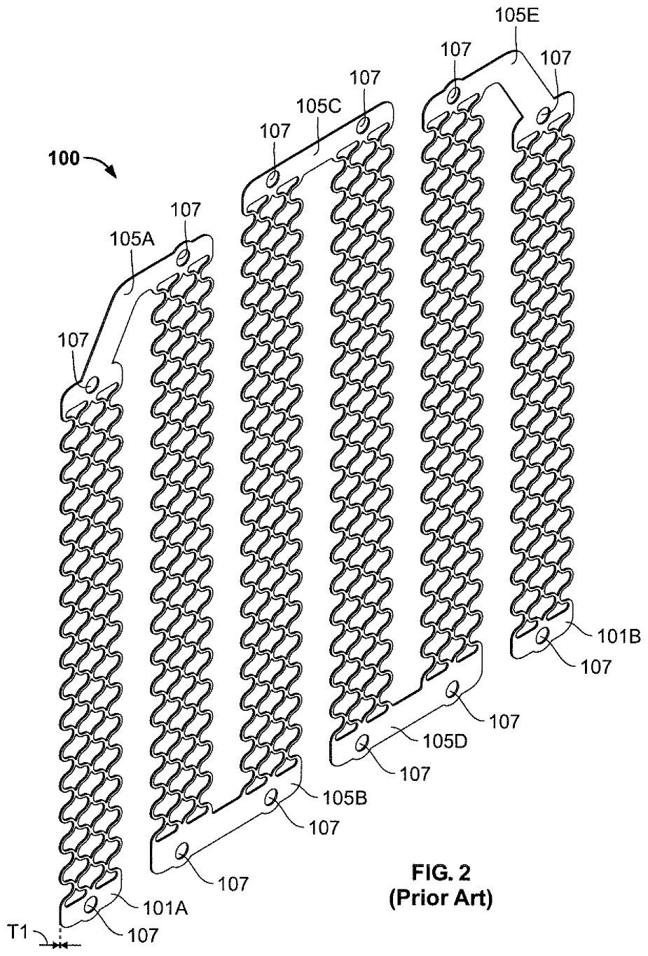

A number of different heating element designs are provided below that provide improvements over heating element designs such as depicted in FIGS. 1-4 above.

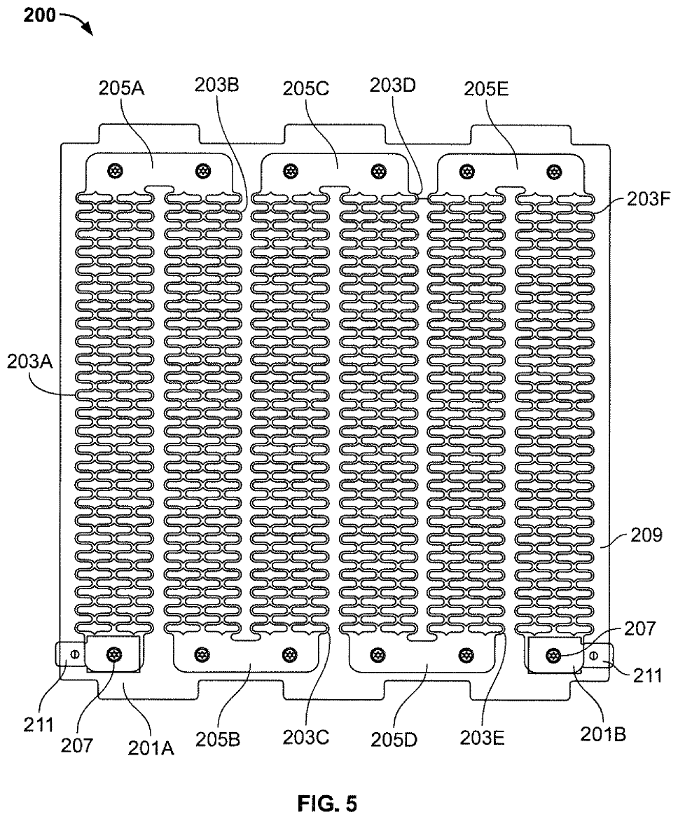

FIG. 5 shows one embodiment of the inventive heating element, which is designated by the reference numeral 200. The heating element 200 has terminals 201A and 201B, heating element segments 203A-F, and busses 205A-205E.

The terminals 201A and 201B are custom configured as compared to the terminals 101A and 101B of FIG. 1. That is, each terminal 201A, 201B, includes a fastener 207, that is secured to a backing plate 209. The terminals also include a connector 211, which is designed to connect to wiring for power or another heating element.

One difference between the heating element 200 in FIG. 5 and that of FIG. 1 is that the lengths of the segments are all the same. With this similarity in length, the busses 205A-205E are the same and do not require any bent portions or elbows as is the case for the heating element 101 of FIG. 1.

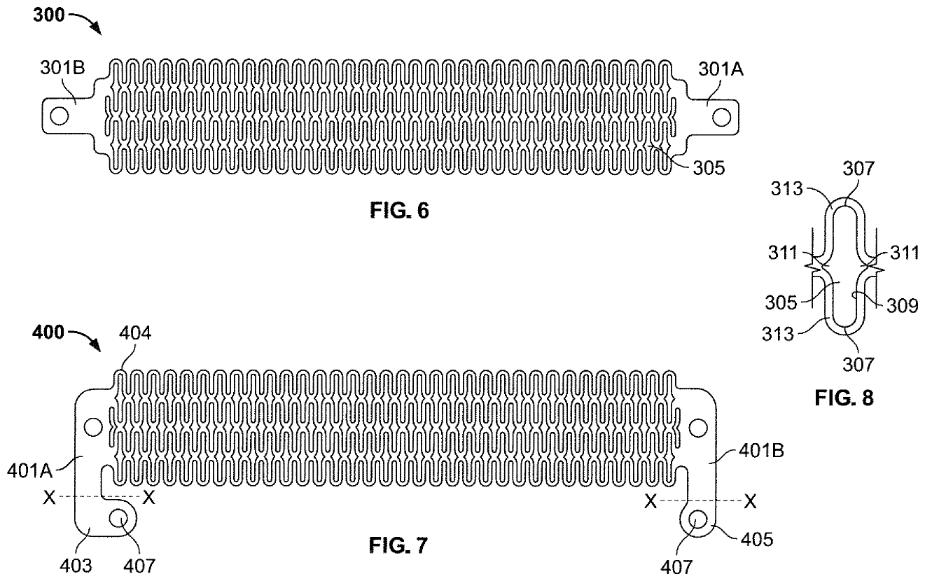

FIGS. 6 and 7 show other embodiments of the inventive heating element. In FIG. 6, the heating element is designated by the reference numeral 300 and is made up of a single heating segment 301 with opposing terminals 303A and 303B. The heating element 300 also has cutouts 305 similarly arranged as shown in FIG. 1.

FIG. 7 shows another type of single segment heating element 400, which also has cutouts 404 like those shown in FIG. 6. This heating element has specially configured terminals 401A and 401B. Terminal 401A has one type of extension part 403 and terminal 401B has another configuration of an extension part 405. Each terminal 401A and 401B has an opening 407. The extension parts can be folded along the line X-X. This folded extension part can be used for mechanical attachment of the heating element using the openings 407. The shape of the extension part 403, 405 can position the opening 407 in a different location when folded to accommodate variations in mechanical attachment needs.

In addition, when the heating element 400 has the necessary thickness and sufficient strength, it can be supported by the extension parts once they are folded. Thus, the heating element 400 can stand on its own, if needed, for a particular heating application.

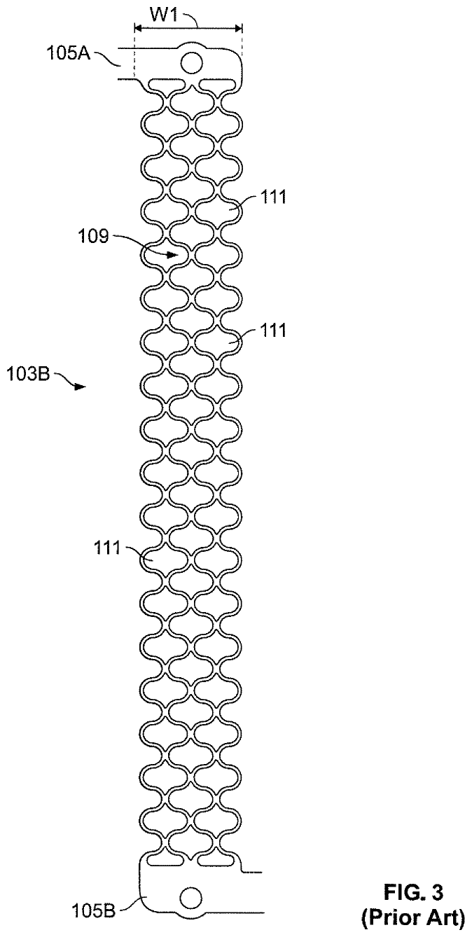

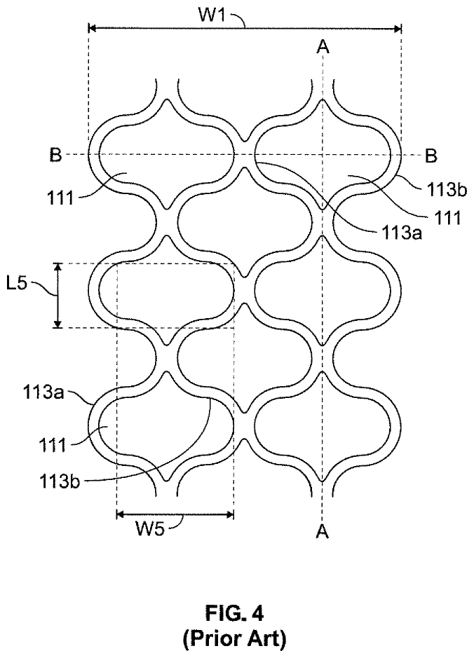

It should also be noted that the cutouts 305 and 404 have a different shape as compared to the cutouts shown in FIG. 4. The cutout 305 of FIG. 6 is shown enlarged in FIG. 8. The cutout 305 is more obround in shape with rounded ends 307, flat side portions 309 with a groove 311 separating the pair of side portions 309. Each groove 311 is created by the travel of each heating segment portion 313 and formation of an adjacent cutout (not shown in FIG. 8) in the pattern of cutouts 305. The obround shape of the cutouts 305 in FIG. 6, differs from the elliptical shape of the cutouts 111 in FIG. 4, for example, including the more slotted shape of the cutouts 305 with the flat portions of the cutout as opposed to the curved first and second walls of the cutouts 111.

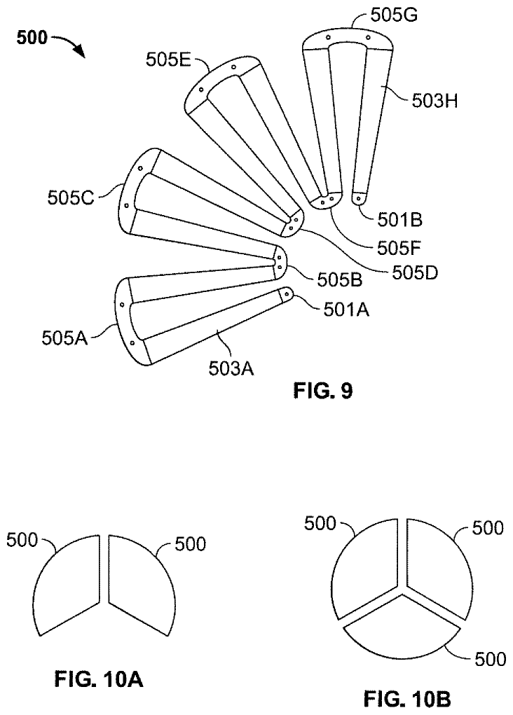

FIG. 9 shows a schematic of yet another configuration of an inventive heating element in the shape of a hand-held fan or extending in an arc shape. For example, the fan-shaped element in FIG. 9 may span 120 degrees. This heating element is designated by the reference numeral 500 and include terminals 501A and 501B, heating segments 503A-503F, although only the laterally outer end segments are given reference numerals. The heating element 500 also includes buses 505A-505G.

The heating element 500 could be grouped with other heating elements to create a larger heating element area. While the fan-shaped element in FIG. 9 is shown spanning about 120 degrees, other degrees of span could be used. Also, if two heating elements 500 are positioned side by side, the heating element could span 240 degrees, see FIG. 10A, and if three heating elements 500 are used, a circular annular configuration could be created as shown in FIG. 10b. This heating element design also demonstrates that the heating element segments can be configured in different shapes to accommodate a particular heating need.

The heating elements of the invention can be used to heat any kind of space once powered. Examples of heating element applications include clothes dryers, particularly for the embodiment of FIG. 9, dishwasher pump heaters, and the other heater applications such as test tube heaters, hot plate heaters, tiny air heaters, miniature ignitors, cartridge heaters, flow through fluid heaters, radiant process and baking heaters, heat for furnaces and ovens, heated radiators, storage heaters, oil and fuel heaters, glow plugs, irons and ironing heaters, water heaters, plastic molding die heaters, soldering irons, hair dryers, and hand dryers. It should be understood that there are merely examples of heaters that could use the heating elements of the invention and the uses of the inventive heating element are not limited to the disclosed example.

While the cutouts are shown with elliptical or obround, other shapes could be employed providing that the shapes that provide the desired resistance heating for a given heating element.

Another embodiment of the invention entails a heating element that is a capable of providing two or more zones having different surface temperatures. With this feature, the heating element can be configured to provide different temperature heating for a particular application, e.g., one zone of the heating element runs at a higher temperature than another zone.

For this embodiment, the heating element is considered to be made up of a number of strands, each strand having a length, with the strands forming diamonds that are part of the heating element. The diamonds are combined together from both a length and width standpoint to form the heating element.

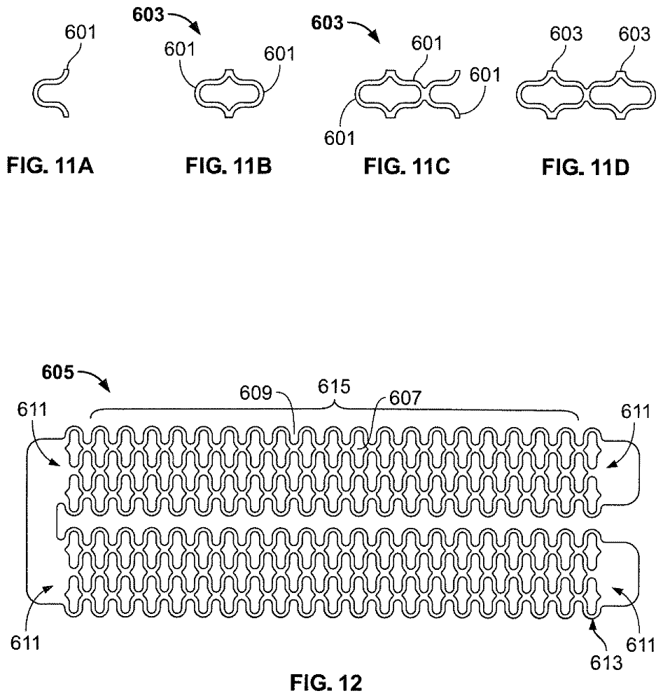

FIGS. 11a-11d show an example of the strands and diamonds for a heating element. FIG. 11a shows a single strand 601, with FIG. 11b showing two strands combined together to form a diamond 603. When an additional strand is added for a total of three strands, 1.5 diamonds are formed as shown in FIG. 11c. FIG. 11d shows two diamonds 603 being formed via the use of four strands.

Using this configuration and controlling the size of the strands, it is possible to produce a heating element using a single sheet of resistance material and intentionally design the circuit trace of the sheet so that different areas of the sheet or heating element will run at different surface temperatures under the same operating conditions for the heating element. With this capability, it is possible to design the heating element to change the surface temperature as needed along the length of the circuit. The fundamental basis for the sheet is the combination of the strands and diamonds described above. It should be understood that the number of strands and diamonds is only limited by the desired heating application for the heating element.

FIG. 12 is an example of a heating element 605. This heating element has a number of strands and full or half diamonds. The full diamonds are shown as 607 and the half diamonds are shown as 609. The diamonds make up a heating element circuit trace, along which current would flow when a particular voltage is applied. The circuit traces shown in FIG. 12 can be made from a single sheet of material whereby the trace can be lengthened so as to increase the current pathway and create more or less total resistance and wattage potential, given a specific applied voltage.

For the heating element 605 in FIG. 12, when considering surface temperatures of such a heating element, it can be understood that certain areas of the final sheet may run cooler than other areas. For the heating element 605, the areas consisting of more material, which are designated as 611 will act to cool a portion of the ends of trace 613 of the heating element and the areas of the traces designated by 615 will run hotter.

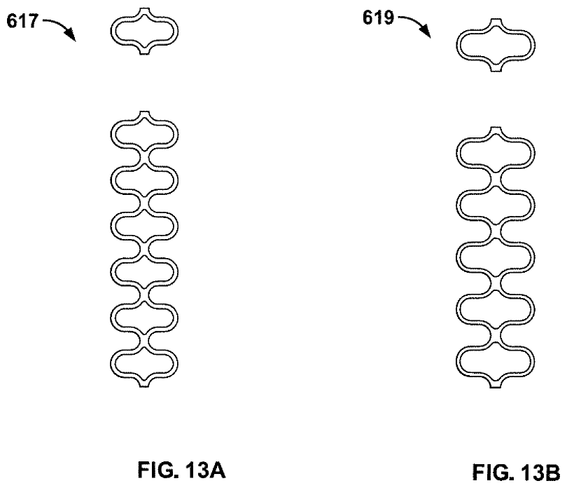

As noted above, a heating element like that shown in FIG. 12 can be modified so that the surface temperature of the heating element along the length of the trace will vary. FIGS. 13a and 13b shows exemplary traces that are designed to provide the desired surface temperature difference for a heating element. FIG. 13a illustrates trace 617 and FIG. 13b illustrates trace 619, both of which are made from the same heating element resistance material of a defined thickness. The trace 617 is made up of 6 diamonds and the trace 619 is made up of 5 diamonds. The dimensions of each trace 617 and 619 are also shown in FIGS. 13a and 13b. More particularly, the six diamond trace 617 has a diamond with a larger width, 0.591 inches, than the diamond width of the five diamond trace 619, whose width is 0.586 inches. The strand width is also larger for the six diamond trace 617, 0.036 inches, as compared to the strand width of the five diamond trace 619, 0.030 inches. The six diamond trace 617 also has a longer length 2.346 inches as compared to the five diamond trace 619, 1.955 inches. The trace 619 does have larger dimensions than the trace 617 in some aspects. The inner width of the diamond for trace 619 is 0.526 inches whereas the width in trace 617 is 0.520 inches. The inner length for a diamond in trace 619 is 0.166 inches, which is larger than the inner length of 0.160 inches for trace 617. It should also be noted that the diamond height for the traces 617 and 619 are actually the same or 0.391 inches. What this means is that the combining the different diamonds as discussed below results in an unnoticeable change to the overall look of the heating element.

With the dimensional differences and difference in amount of material as a result of using 6 diamonds versus five diamonds, the two traces 617 and 619 have the same resistance (ohms). With this same resistance, if the same voltage is applied to each trace, each trace would produce the same watts and draw the same current in amps.

However, under these equal conditions, since one circuit trace 619 has less total material that the circuit trace 617, and is running the same amperage, the surface temperature will be higher for the circuit trace with less material. As an example, assume that each circuit trace shown here will run 10 Watts @ 2.875 volts. This would result in the trace 619 running at a surface temperature T2, which is greater than the surface temperature T1 of trace 617 under the same running conditions.

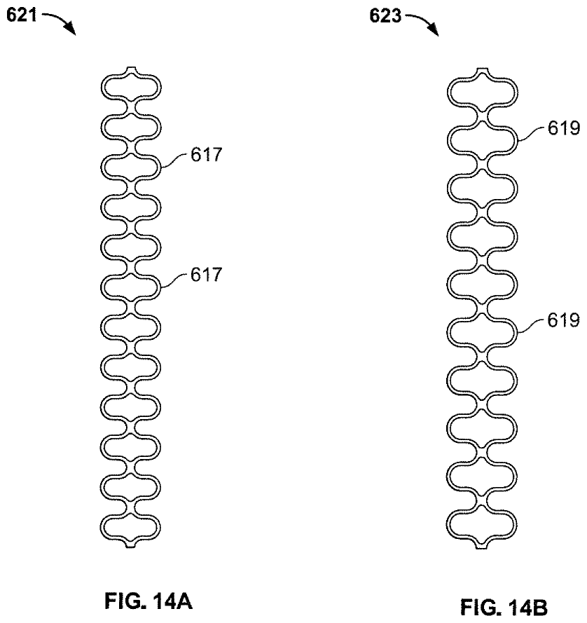

FIGS. 14a and 14b show a variation of the embodiment shown in FIGS. 13a and 13b. Here, a trace 621 is shown in FIG. 14a, the trace 621 made up of the two sub-traces 617, with a total of 12 diamonds. FIG. 14b shows trace 623, which is made up of 10 diamonds or two sub-traces 619. The traces 621 and 623 are used under running conditions of 20 watts at 5.75 volts. In this design, each sub-trace 617 in the trace 621 would run at temperature T1 as compared to each sub-trace 619 in the trace 623 running at temperature T2. T2 is greater than T1 as a result of the lesser material in trace 623 race with 10 diamonds as opposed to the twelve diamond trace 621. As explained in connection with FIGS. 13a and 13b, the resistance value of the traces 621 and 623 would be the same as they are merely a combination of sub-traces 617 and 619, respectively.

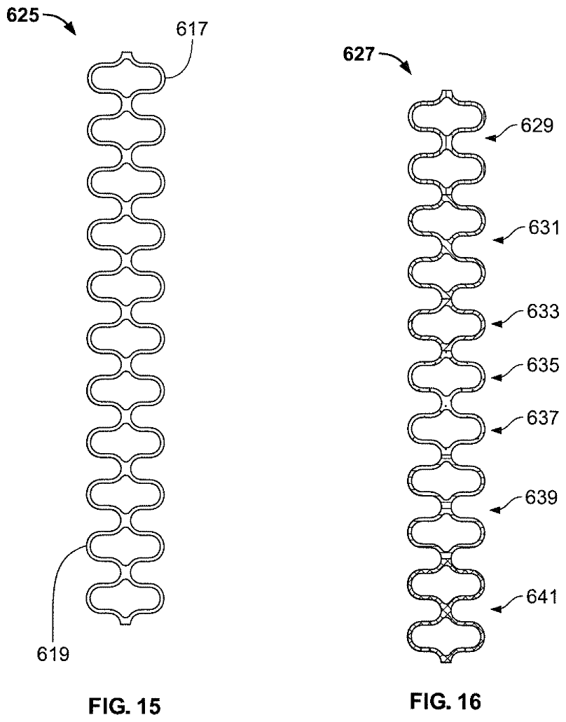

From the above, it is established that that both traces 621 and 623 can run 20 Watts @ 575 Volts, and it is further established that due to the material content, the trace with less material, i.e., trace 623, will produce a higher surface temperature. By modifying this trace design by combining sub-traces 617 and 619 as one trace, a heating element running at two different surface temperatures is provided. This is illustrated in FIG. 15, wherein a new trace 625 is provided, wherein sub-trace 617 with six diamonds is paired with sub-trace 619 with five diamonds. This trace would product 20 watts of heating at 5.75 volts but one portion of the circuit trace will run at a surface temperature T1, which is lower than the other portion, which runs at T2 due to less material being in the trace portion.

The trace 625 is but one example of designing a heating element that will have different surface temperatures and therefore a different heating effect for a desired application. FIG. 16 is another example of multiple traces combined together to provide a multiplicity of different surface temperature for the circuit trace. In FIG. 16, the trace is designated by the reference numeral 627. This trace is made up of a plurality of sub-traces. Viewing the trace 627 from the top down, a first sub-trace 629 is provided made up of two diamonds. A second sub-trace 631, which also is made up of two diamonds, is added to the first sub-trace 629. A third sub-trace 633, which is made of one diamond, is added to the second sub-trace 631. Fourth and fifth one diamond sub-traces 635 and 637 are provided after the third sub-trace 633. Two additional sixth and seventh two diamond sub-traces 639 and 641 are provided after the fifth sub-trace. Adjacent sub-traces can be designed so that there is a difference surface temperature between adjacent traces. For example, sub-traces 629 and 631 could be designed so with the same resistance but lesser material in sub-trace 631 so that the surface temperature T2 of sub-trace 633 is greater than the surface temperature T1 of sub-trace 631. Then, sub-trace 635 with one diamond would run hotter than sub-trace 633 and surface temperature T3 would be greater than surface temperature T2. Designs for the remaining sub-traces 635, 637, 639, and 641 could be provided so that the surface temperature increases sequentially. However, the sub-traces could also be designed by material amount and resistance so that the surface temperatures could decrease from a particular sub-trace or oscillate between lower and higher surface temperatures if the heating application required such temperature changes.

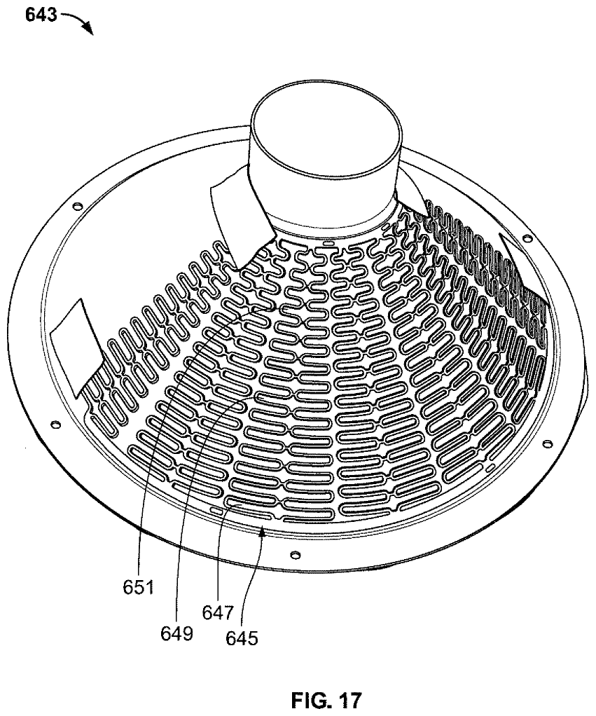

While the diamond shape in FIG. 16 essentially stays the same, and there would be changes in terms of the number of diamonds for a sub-trace, or strand width, diamond width etc., the shape of the diamond could also change along the length of the trace to have the different surface temperature effect. This embodiment is shown in the heating element of FIG. 17, which is designated by the reference numeral 643, and which has a conical shape. This heating element shape is similar to that shown in FIG. 9 above wherein the profile of the trace changes along its length. In FIG. 17, seven traces are illustrated to make up the heating element and one is identified by reference numeral 645. The trace 645 is made up of a number of diamonds, with the diamonds decreasing in size towards the narrower diameter portion of the heater. Thus, diamond 647 is larger than diamond 649 and diamond 649, in turn, is larger than diamond 651. Along the length of the trace 645, the material length in the trace decreases so that the heating element would provide fewer watts to this smaller surface area as the conical shape tapers to its smaller end. Provided the element strand is designed equally, this trace section of fewer watts would be applicable to less surface area and thus the watts added to the shape would be equal in density. In this manner, the conical shape could thus have an even surface temperature, although this surface reduces as the shape tapers. Additionally, as has been detailed prior, the design of the trace can be altered so as to change the element temperature along its length. In this manner, heat added to the conical shapes surface can be made unequal in density and thus the conical shapes surface temperature can be made unequal and therefore can be variably controlled with the trace design. Such control can be required when thermal losses are uneven during the applications operation.

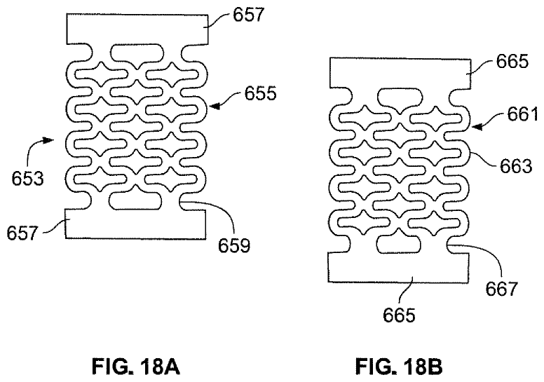

Another aspect of the inventive heating element pertains to improving the heating element performance when considering the terminal sections of the heating element. FIG. 18a shows one type of a heating element, which is designated by the reference numeral 653. This element includes a trace 655 and terminal ends 657 and a strand width of 0.125 inches. With this strand width, the junction 659 between the terminal ends 657 and the trace 655 has a width of 0.250 inches. In FIG. 18b, the heating element, which is designated by the reference numeral 661, has a trace 663 and terminal ends 665. The trace 663 has the same strand width the same as that of FIG. 18a, i.e., 0.125 inches. However, the junction 667 between the terminal ends 663 and the trace 661 is made to have a thickness of 0.375 inches as opposed to the 0.250 inch thickness of the junction 659 in the heating element of FIG. 18a. In this way, the additional material at the junction 667, this portion of the heating element runs cools and any problems with the terminal portions of the heating element being subjected to excessive heat are reduced.

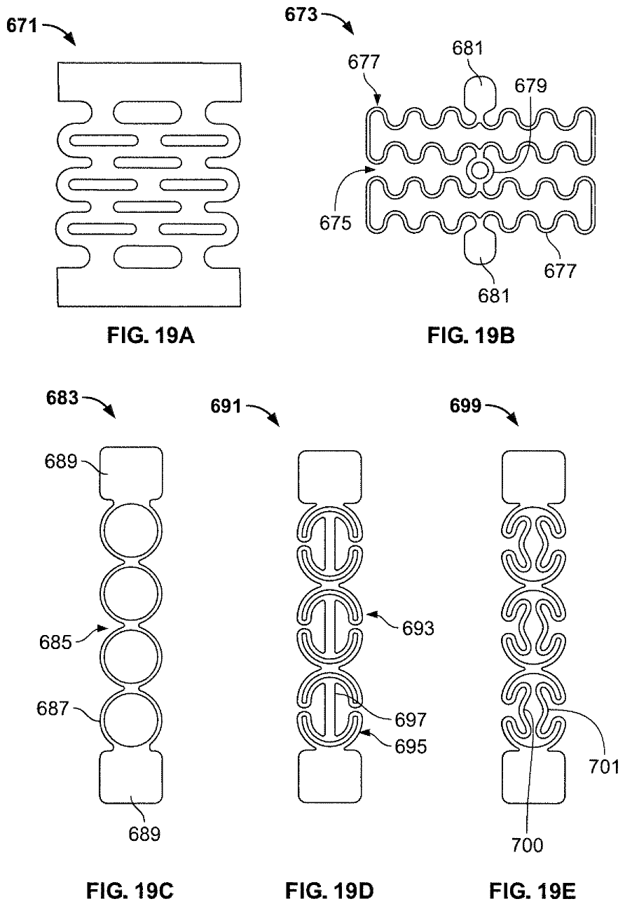

It should be understood that the diamond shapes shown above are only examples of a trace circuit for accomplishing the variable surface temperature capability. FIGS. 19a-19e show different embodiments of traces for a heating element. FIG. 19a shows a heating element 671 with slots without the flared-out center portions of the diamonds as shown in FIG. 18b. FIG. 19b shows another heating element 673 with a trace 675 containing elongated sections 677, each section disposed between a power connector 679 and a terminal end 681. FIG. 19c shows yet another heating element 683, wherein the trace 685 is made up of circular sections 687, which extend between the terminal ends 689. FIG. 19d shows another heating element 691, wherein the trace 693 is made up of a number of sections 695, wherein for each section 695, the strands form a u-shape, and an inverted u-shape, with a single connector 697 therebetween. FIG. 19e is a variation on the section shape of FIG. 19d, wherein, for a heating element 699, instead of single connector for the pair of strands for the two shapes of the section, separate strands 700 and 701 are used to connect the u-shape part of the section to the inverted u-shape part of the section.

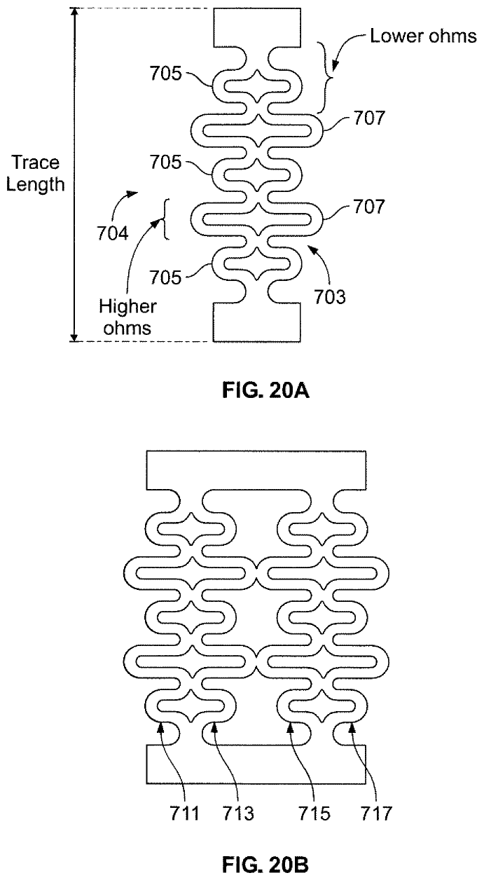

Other examples of different shaped diamonds in a trace of a heating element are depicted in FIGS. 20a and 20b. In FIG. 20a, the heating element, which is designated by the reference numeral 703, has a trace 704 and diamonds 705 and diamonds 707. Diamonds 705 represent a lower ohm section of the trace 704 and the diamonds 707 represent a higher ohm section of the trace 704. FIG. 20b shows a variation on the heating element of FIG. 20a, which is designated by the reference numeral 709, wherein a pair of traces 704 are used with four strands 711, 713, 715, and 717.

As shown in FIGS. 20a and 20b, it can be seen that the actual “diamond” type shape can be made larger or smaller, as needed. This change allows current to flow along a longer pathway where the designer wishes. This effect will place joule effect heating into specific areas depending upon the application requirement. For the heating elements of FIGS. 20a and 20b, the trace resistance value increases per unit trace length in the areas with longer strands. However, the actual individual strand resistance per length of the strand remains the same, i.e., for FIG. 20b, each of the strands 711, 713, 715, and 717 are equal in resistance per strand length. For the heating elements in FIGS. 20a and 20b, the lower ohm sections would run fewer total watts than the higher ohm sections, thus providing the capability to provide different levels of heat for a given trace.

For heating elements in general, it is known that making these heating elements using an expanded metal technique as described above is a more efficient use of the heating element resistance material. However and as noted above, this technique also brings with it the problem of cracking at junctions of the strands and uneven heating as a result thereof. Forming heating elements using a stamping method, photolithography method, or other similar techniques is not as efficient from a material use standpoint as these kinds of expanded metal heating elements, but these heating elements do not have the cracking problem that expanded metal heating elements have.

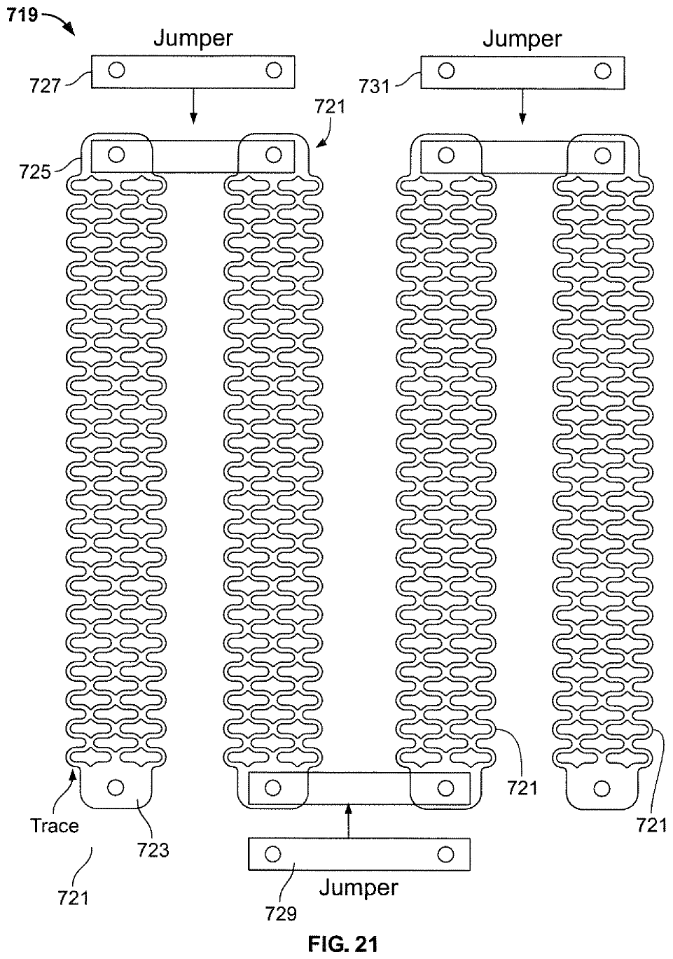

The problem of having to use more material when making heating elements that are not from expanded metal can be alleviated by making smaller trace circuits and connecting them together using a jumper or other connecting device. Referring now to FIG. 21, a heating element, which is designated by the reference numeral 719 is made up of four separate circuit traces, each identified as 721. Each trace has terminal ends 723 and 725. The heating element 719 includes three jumpers 727, 729, and 731. Jumper 727 connects the first trace to the second trace. Jumper 729 connects the second trace to the third trace and jumper 729 connects the third trace to the fourth trace. With this configuration, there is much less material waste of the heating element resistance material as the jumpers only need to be made of a conductive material but not one that is used for resistance heating. While four trace circuits are shown, any number of circuits and circuit configurations could be employed in such a heating element design.

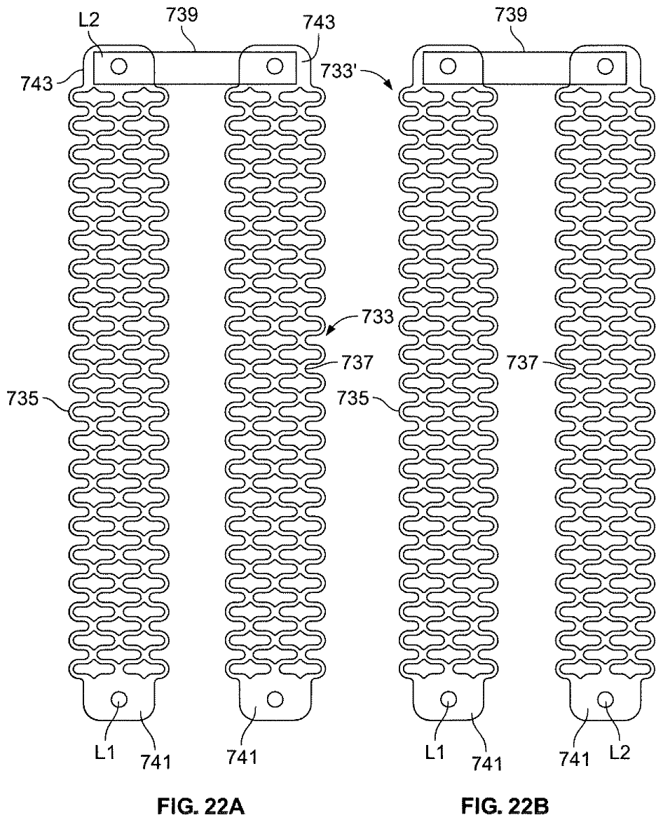

The heating element of FIG. 21 also allows for different locations for voltage application. FIGS. 22a and 22b show embodiments in this regard. In FIG. 22a, the heating element 733 has two traces 735 and 737 and one jumper 739. Voltage can be applied to just trace 735 by connections L1 and L2 to the terminals 741 and 743 of the heating element 733 and only trace 735 is used for heating. In FIG. 22b, the voltage is applied across the terminals 741 of each of the traces 735 and 737 so that both traces are used for heating.

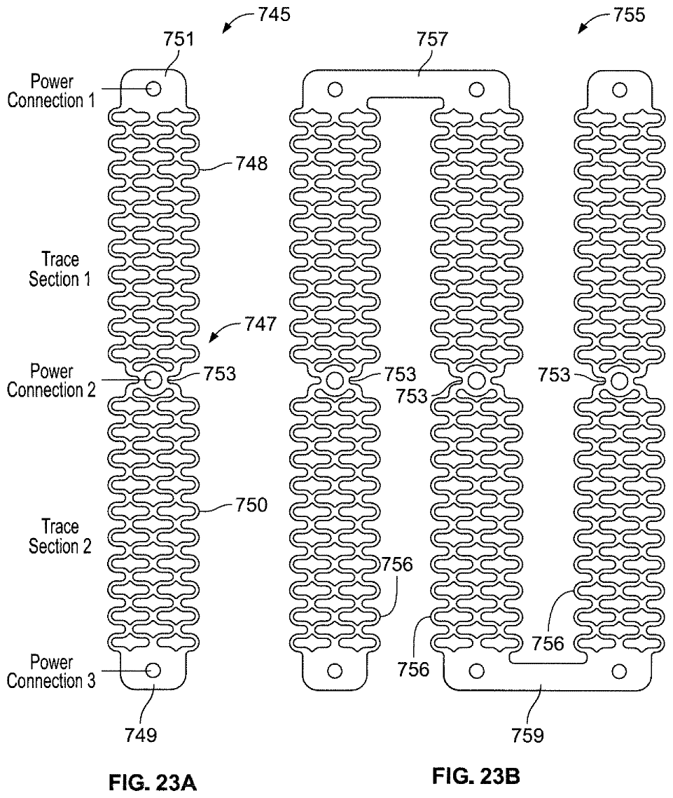

Another embodiment of the configuration of the heating element is shown in FIGS. 23a and 23b. FIG. 23a shows a single trace heating element 745 that has a trace 747, terminals 749 and 751, and a power connector 753. The power connector 753 divides the trace 747 into two trace sections 748, 750. FIG. 23b shows a three trace heating element 755, with the same kind of power connector 753 as shown in FIG. 23a, each trace having trace sections 756 separated by the power connector 753, similar to that shown in FIG. 23a. The heating element 755 employs bus connections 757 and 759 to link the traces together. With the multiple power connectors, many different levels of heating can be provided. For example, one or both trace sections in FIG. 23a could be used. Similarly, from one to all of the six sections of the three traces shown in FIG. 23b could be employed with the appropriate power connection to either the terminals or power connections separating the trace sections. Additionally, the points defined as a power connector 753, could be used to fasten the element to some object or surface to be heated. In securing the element at locations 753, (the element) when heated would be held more securely during thermal expansion. This added securement as a thermal expansion control fastener could be used to prevent excessive movement of the element at elevated temperatures where this thermal expansion could become a problem.

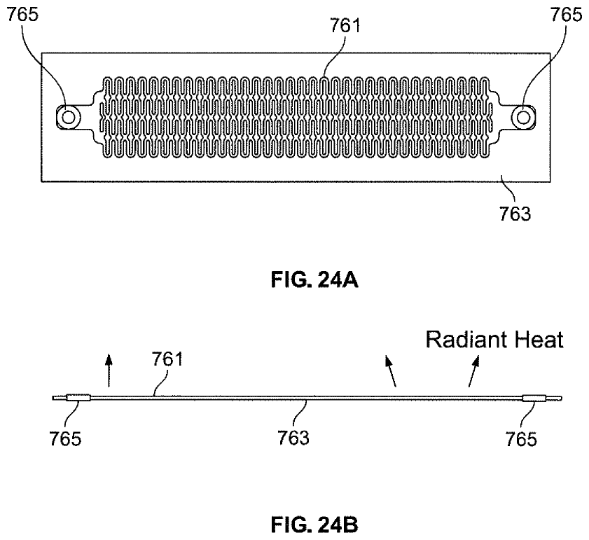

The heating elements of the invention can be used in different ways in connection with an insulator that would form part of a heater structure to provide different kinds of heat. In FIGS. 24a-b, a thin foil heater trace 761 is shown fastened to a mica plate 763 (or other insulator) using fasteners 765, the top view shown in FIG. 24a and the side view shown in FIG. 24b. With the heater trace 761 mounted to one face of the mica plate 763, the heater trace provides radiant heat in the direction shown by the arrow for an intended application.

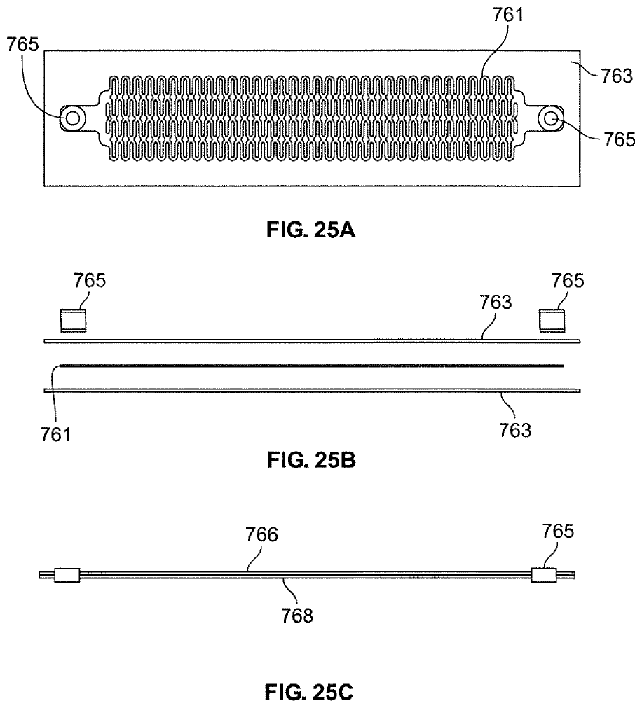

FIGS. 25a-c shows another variation on a heating application of a heater trace, shown in top view (FIG. 25a), disassembled side view (FIG. 25b), and assembled side view (FIG. 25c). In this embodiment, the heater trace 761 is sandwiched between two mica plates 763, all fastened together using fasteners 765. With the heater trace 761, between the mica plates 763, the heating element functions as a conductive heater with hot surfaces 766 and 768, wherein an object placed on the outer surface of the top mica plate 763 would be heated by conduction due to contact with the hot surface 766.

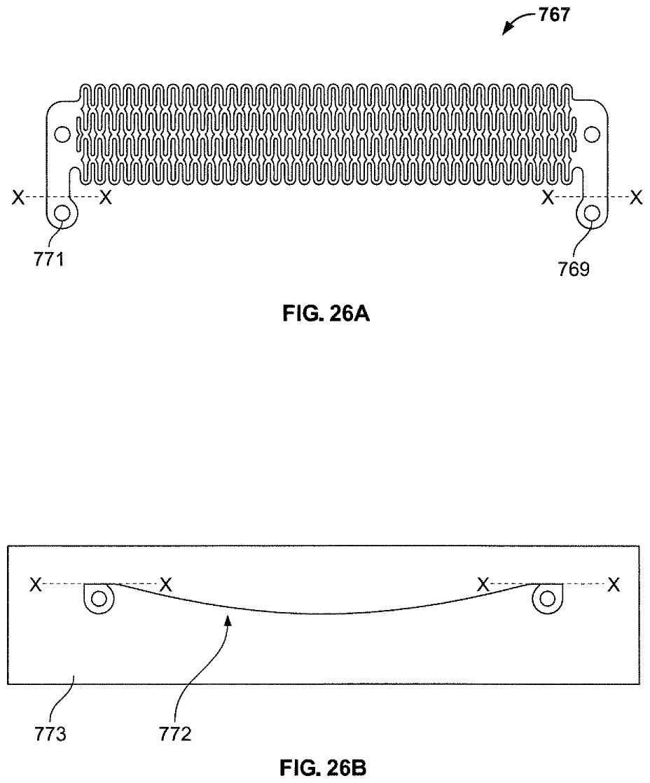

The inventive heating element can also be used as an air heating device, wherein heat transfer occurs by convection rather than conduction or radiation. In this embodiment, which is shown in FIGS. 26a-b and referring back to the description of FIGS. 6 and 7 above, a heating element 767 is shown with extension parts 769 and 771. The extension parts can be folded along the line X-X to create a stand-up heater 772 as shown in FIG. 26b. Here, the folded heater parts 769 and 771 would be attached to a mica plate 773 to create the standup heater.

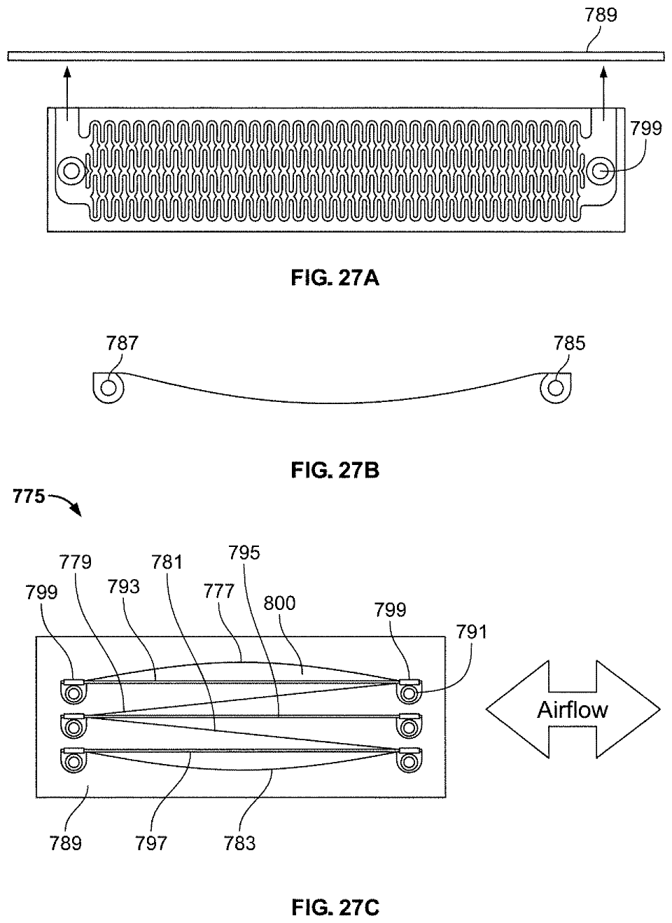

Another variation on a stand-up heater is shown in FIGS. 27a-c and designated by the reference numeral 775. FIG. 27a shows the heater in a partly disassembled state, FIG. 27b shows one of the traces from a top view, and FIG. 27c shows an assembled heater. In this embodiment, the four heater traces are used with four mica plates, one base mica plate 789 and three separating mica plates 793, 795, and 797, and 12 fasteners 791. The heater traces 777, 779, 781, and 783 each have extension parts 785 and 787 to allow the heater traces to be fastened to the base mica plate 789 using fasteners 791. The heater traces are also attached to the three other separating mica plates 793, 795, and 797 using fasteners 799. With this construction, a small heater is made that has the heater traces spaced from the mica plates, see, for example, gap 800 in FIG. 27c. This lack of contact removes the heat that would be lost to conduction through the mica surfaces and allows the heater to be used for convection heating when air travels in the direction shown in the drawing. This heater also requires very little air flow to prevent the surfaces of the heater traces to produce visible radiant heat.

Another aspect of the invention is the ability to take a heater trace and form it three dimensionally to provide a heating element that is not just two dimensional. FIGS. 28a and 28b show one example of such a three dimensional heater with the flat heater trace 800 with its terminals 801 and 803 of FIG. 28a shaped to form a semi-circular configuration or rolled round shape as shown in FIG. 28b. The heater trace 800 could be a type wherein the heater trace is designed to have two or more different surface temperatures so that the heat provided in the three dimensional shape varies along the length of the heater. Alternatively, the heater trace could be like the heating element disclosed in FIG. 6, wherein the heater trace would have a uniform surface temperature along its length.

Another variation of the heater of FIGS. 28a and 28b is to take two of the heater traces and connect them to form a cylindrical shape. Voltage could be applied to the unconnected ends of the heater traces to form a series circuit using both of the semi-circular shaped heater traces. This cylindrical configuration could be used as a cartridge heater as shown in FIGS. 29a-b, wherein the cartridge heater is designated as 810, with the heater 811 positioned in an insulating medium 813, e.g., a ceramic insulation, potting compound, or the like. FIG. 29a shows a side view of the heater with FIG. 29b showing a schematic of how the heater looks in cross section. The traces would be connected at one end 814 using the terminals 816 and the other end of the trace would be connected to a power source. With this configuration and the ability to control the surface temperature along the length of the trace, the heater can be inserted into a pipe and provide added control over heat distribution per unit length of the pipe. As with the embodiment of FIGS. 28a and 28b, the heater trace would be one that has the same surface temperature over its length or a varied surface temperature over its length.

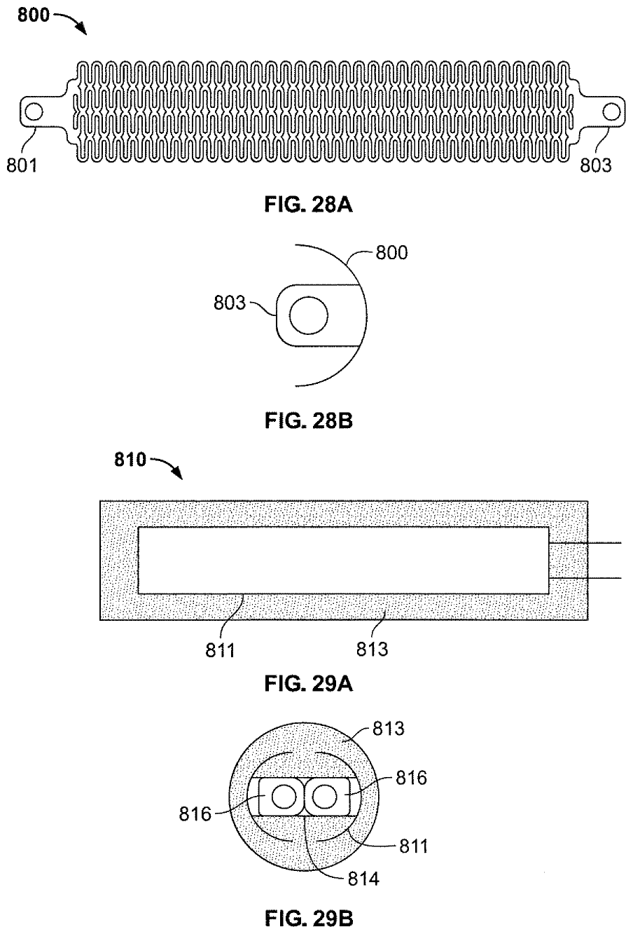

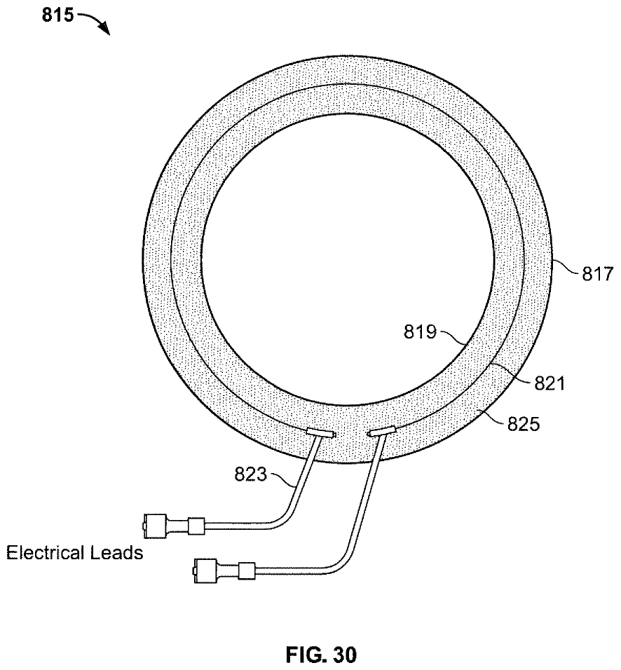

An additional embodiment of the invention is shown in FIG. 30, which is similar to that of FIGS. 29a-b. In this embodiment, a heater is designated by the reference numeral 815. The heater includes an outer pipe 817, and inner pipe 819, a heater trace 821, with leads 823 extending through the outer pipe 817. The heater trace 821 is held in place between the pipes using an insulating medium 825, e.g., a ceramic insulation, potting compound or the like. This heater 815 could be used to heat material flowing through the inner pipe 819. As with the embodiments of FIGS. 28a, 28b, 29a, and 29b, the heater trace could be one that provides a uniform surface temperature over its length of a varied surface temperature over its length.

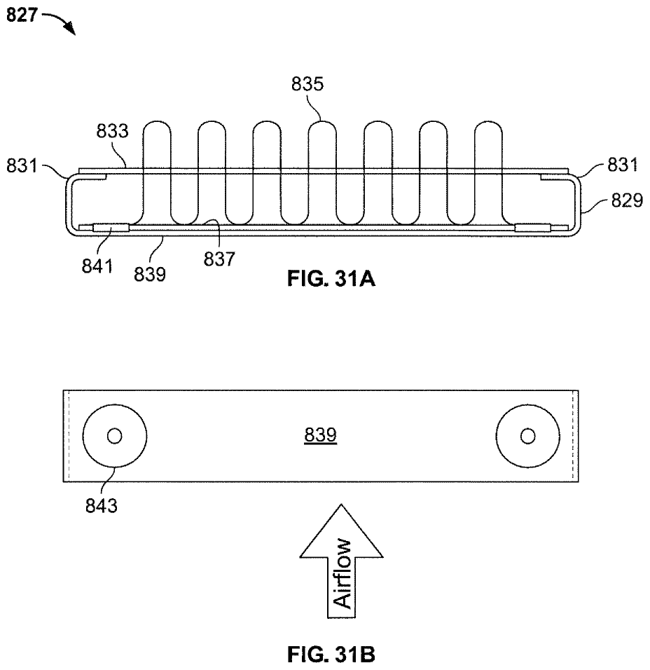

One further three dimensional heater embodiment using a heater trace is shown in FIGS. 31a-b. In these Figures, the heater is designated by the reference numeral 827, with FIG. 31a showing a front view and FIG. 31b showing a bottom view. The heater includes a frame 829. Ends 831 of the frame 829 are flanged to support a mica plate 833. A heater trace 835 is provided and formed to have a sinusoidal shape, with the heater trace 835 passing through openings (not shown) in the center mica plate 833. Another or bottom mica plate 837 is provided to electrically isolate portions of the heater trace 835 from the frame bottom portion 839. The frame bottom portion 839, mica plate 837 and terminal ends of the heater trace 835 are secured together at 841. This securement could be any kind of fastening to provide electrical isolation between the frame bottom portion 839 and heater trace while leaving a clearance hole 843 through the frame bottom portion 839 to allow the heater trace 835 to be connected to power for heating purposes. This embodiment is ideally suited for heating an airstream with the air flow direction shown in FIG. 31b. The heater trace surface can be shaped and turned to be dimensionally stable in this design and made compact into a small space that would be difficult to do with prior art designs.

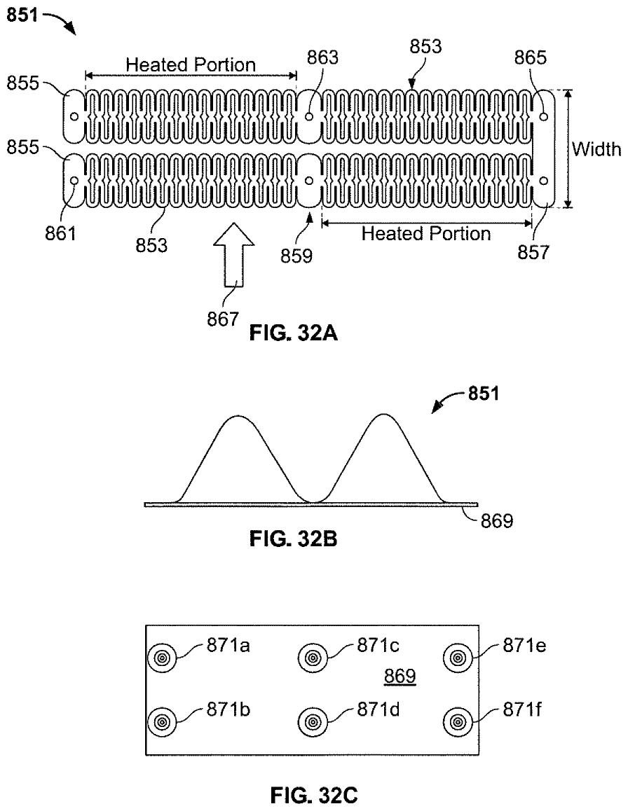

Further embodiments of the invention are shown in FIGS. 32a-34c. The embodiments relate to the concept of avoiding the need to pre-form the circuit trace prior to its use in making a heating element assembly. In FIGS. 31a-b, it may be necessary to pre-form the heating element so as to fit into the supporting structure. In FIGS. 32a-32c, there is no need to pre-form the heater trace portions as the configuration of the heater trace portion allows the shape of the heater trace portions to be determined as part of the assembling the heater element assembly.

FIG. 32a shows a heater trace 851 to be used in a heater assembly. The heater trace 851 includes a pair of heater trace portions 853. The heater trace 851 has two terminals 855 and a bus connector 857. A fastening section 859 is provided in the middle of each heater trace portion 853. Each of the terminals 855 has an opening 861 for fastening purposes. The fastening sections 859 also have openings 863 and the bus connector 857 has a pair of fastening openings 865.

The heater trace 851 is shown lying flat in FIG. 32a, with the arrow 867 representing a preferential air flow direction that would flow across the trace 851 when in a heater assembly during heating.

FIGS. 32b and 32c shows the heater trace 851 in an assembled state with a mica support plate 869. The bottom view of the support plate 869 is shown in FIG. 32c. More particularly, with the fastening of the terminals 855, fastening sections, 859, 863, and bus connector 857 to the mica plate at points 871a-e, the heater trace is formed in a sinusoidal shape. That is, with the location of the fasteners on the mica support plate 869, the heater trace shape extends naturally and outwardly from the mica support plate 869 as a result of the fastening process. This self-forming shape eliminates the need to pre-form the heater trace 851 before installation.

In this configuration, the moving fluid is able to flow over the heater surface of the trace so as to maximize the heat being drawn from the surface and transfer it to the moving fluid. The flow is best if flowing parallel to the heater trace width, in order to best prevent the heater trace from heating itself.

While the heater trace of FIG. 32a-c is shown with a pair of heater trace portions, a single heater trace like that shown in FIG. 6 could be used to form a three dimensional heating element. In this FIG. 6 embodiment, the terminals 301A and 301B would be fastened to a support plate that would have a length less than the length of the heater trace so that the heater trace 300 would be curved after attachment to the support plate using fasteners. That is, instead of two curves as shown in FIG. 32b, only one curve would be present. Other combinations of terminals, bus connections, a support plate or plates, and numbers of heater trace portions can be combined to form various three dimensional shapes. Also, while the relative shapes of the heater trace and support plate differ in terms of length, other shape differences between the heater trace and support plate(s) could be employed so that the fastening of the heater trace to the support plate would impart a three dimensional shape different than the sinusoidal shape shown in FIG. 32b.

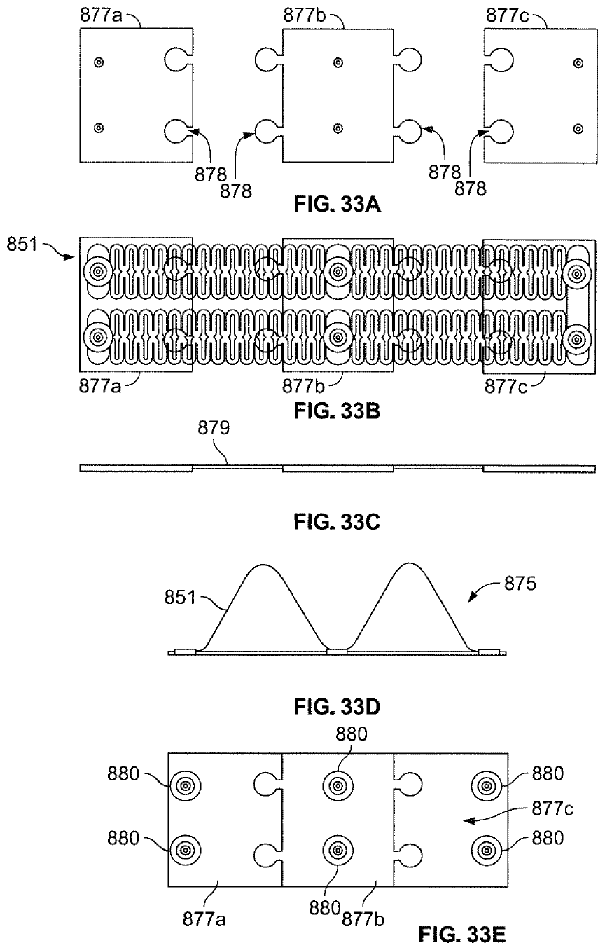

A variation of the design of FIGS. 32a-32c is shown in FIGS. 33a-33e and this heater assembly is designated by the reference numeral 875. Instead of using a single support plate like that of FIG. 32c, multiple support plates 877a, 877b, and 877c are provided. Each of the plates has a connecting feature 878 so that the plates can be linked together to form one plate assembly of large size than the individual support plates 877a-c. The plates 877a, 877b, and 877c are shown with an exemplary length of 0.875 inches.

In FIG. 33b, the heater trace 851 is shown fastened to each of the support plates 877a-c while in a flat state. FIG. 33c shows the plates 877a-c held in a spaced apart arrangement by a fixture 879. The fixture holds the plates in position to allow the fastening of the heater trace 851 to the plates.

Once the heater trace is fastened to the plates, the plates 877a-c are connected together using the connection features 878 to form the heater trace with its sinusoidal shape, see FIGS. 33d and 33e. With three 0.875 inch plates 887a, 877b, and 877c, the overall length of the connected plates is 2.625 inches. The illustrated dimensions are examples only and other dimensions can be used. With the connection features 878 as part of the plates 877a-877c, the plates can be snapped together like a puzzle. An additional bottom plate (not shown) that matches or approximates the shape of the combined plates can be used for further support if strengthening of the assembly is required. The flexible nature of the heater trace makes the elimination of any preforming step possible and improves the manufacturing efficiency of the heater assembly. While the connection features are shown as an opening in one plate and an opposing male connector in an adjacent plate, other shapes or configurations can be used that would allow adjacent plates to be connected together.

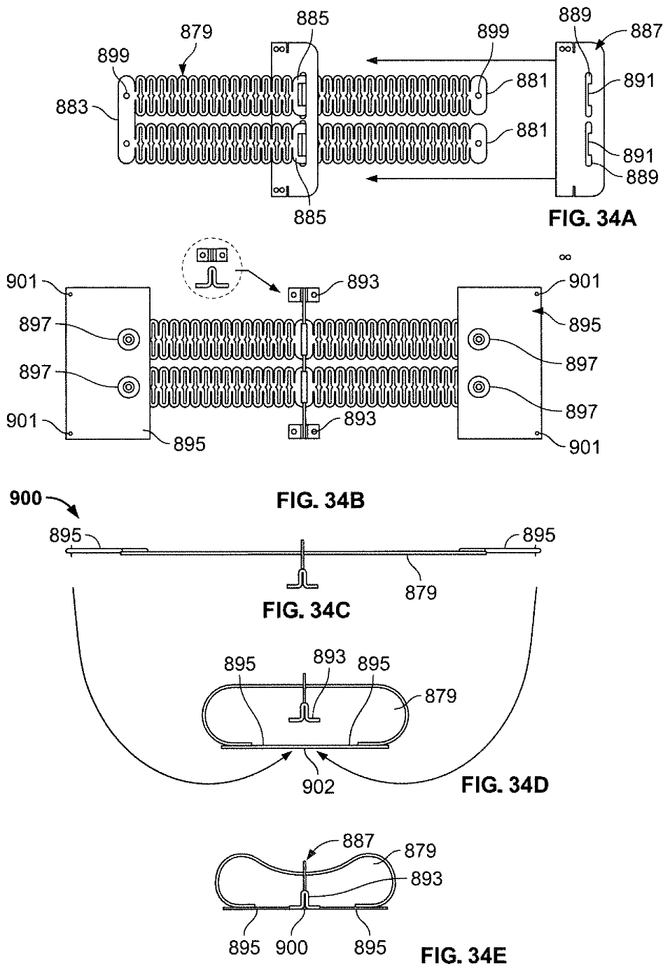

FIGS. 34a-e show yet another variation of using a flat heater trace and forming it into a desired shape as part of assembly of the heater. FIG. 34a shows a heater trace 879, the trace 879 having terminals 881, a bus connector 883, and a pair of intermediate sections 885. For this trace 879, a center support plate 887 is provided. The center support plate 887 has two slots 889, each slot 889 designed to interface with each intermediate section 885 of the trace 879. More particularly, each intermediate section has a slot (not shown) that is sized to receive each tab 891 in the slot 889 of the center support plate 887. The center support plate 887 is shown by itself on the right side of FIG. 34a and also attached to the intermediate section 885.

Referring now to FIG. 34b, the center support plate 887 also has a pair of mounting brackets 893, shown in top and side view in the circled view of the bracket 293, disposed on ends of the center support plate 887. Also provided is a pair of support plates 895, which have fastening portions 897, which are designed to interface with the openings 899 in the terminals 881 and bus connector 883. Once the support plates 895 are fastened to the terminals 881 and bus connector 883, the heater assembly 900 is in a flat state as shown in FIG. 34c.

The support plates 895 are then moved so that the heater trace 879 bends and the ends of the plates 895 are arranged to face each other at junction 902. This configuration is shown in FIG. 34d and the heater trace has a c-shaped cross sectional profile.

After the support plates 895 are moved to be in the abutting relationship shown in FIG. 34d, the mounting brackets 893 are fastened using the openings 901 in the support plates 895 to form a fully assembled heater 900.

The final shape of the heater trace 879 is a complex one, that is only obtainable as a result of the heater trace flexibility and the ability to form the shape using the fastening steps to connect all of the heater components together. As with the other embodiments of FIGS. 32a-34e, a complex assembled heater can be efficiently and effectively made without the need for a heater trace pre-forming step. That is, the assembly shown in FIG. 34c lays flat and only takes on its complex shape with the step of connecting the plates 895 using the mounting brackets 893. The mounting brackets are just one example of how the plates 895 can be connected together and other ways could be used as well. For example, the plates 895 could be joined together at 902 first and then the center support plate 887 is attached. In any event, the use of the heater trace as shown in FIGS. 32a-34e provides a significant savings in manufacturing time, which results in a lower cost heater assembly.

The various embodiments described above are provided by way of illustration only and should not be construed to limit the claims attached hereto.

Those skilled in the art will readily recognize various modifications and changes that may be made without following the example embodiments and applications illustrated and described herein, and without departing from the true spirit and scope of the following claims.

We claim:

1. A heating element comprising:
first and second terminals; and
one or more heating element segments extending between the first and second terminals, each heating element segment having a plurality of cutouts arranged in a repeating pattern, each cutout having an elliptical or obround shape;
wherein the first and second terminals and the one or more heating element segments are a continuous single sheet of material, wherein at least one of the first and second terminals includes an extension part that can be folded with respect to the heating element.

2. The heating element of claim 1, wherein each of the first and second terminals includes an extension part that is folded with respect to the heating element, the heating element standing alone on the folded extension parts.

3. The heating element of claim 1, comprising a plurality of heating element segments, the plurality of heating element segments extending in an arc.

4. The heating element of claim 1 comprising a set of the plurality of heating elements extending in the arc, the set forming an arc shape or a circular shape.

5. A method of heating comprising:
a) providing the heating element of claim 1 in a space, and
b) supplying power to the heating element to heat the space.

6. A heating element comprising:
at least first and second terminals; and
one or more heating element segments extending between the at least first and second terminals, the one or more heating element segments have a circuit trace that includes at least first and second portions, the at least first and second portions configured so that a surface temperature difference exists between the at least first and second portions when a voltage is applied between the at least first and second terminals.

7. The heating element of claim 6, wherein the heating element segment has a three dimensional shape.

8. The heating element of claim 7, wherein the three dimensional shape is one of a semi-cylindrical shape, a cylindrical shape, and a sinusoidal shape.

9. A heater having the heating element of claim 8, wherein the heating element has the cylindrical shape and the heating element is disposed in an insulating medium for heating or the insulating medium is positioned between an inner pipe and an outer pipe for heating material flowing through the inner pipe.

10. The heating element of claim 6, further comprising at least one power connection or thermal expansion control fastener location disposed between the at least first and second portions of the circuit trace.

11. A heating element assembly comprising a plurality of the heating elements of claim 6, and at least one juniper connecting the at least the first terminals of the plurality of heating elements together.

12. The heating element of claim 6, wherein the circuit trace has a plurality of first diamonds and a plurality of second diamonds, the plurality of first diamonds configured to have lower resistance that the plurality of second diamonds.

13. The heating element of claim 6, wherein the circuit trace has a plurality of diamonds and a width of the plurality of diamonds continuously tapers between the at least first and second terminals or a width of the one or more of the plurality of diamonds varies along a length of the circuit trace.

14. The heating element of claim 6, wherein the circuit trace has a plurality of diamonds, the diamonds having a strand width, and a width of a connection between at least one of the at least first and second terminals and a diamond adjacent to the at least one of the first and second terminals is larger than the strand width.

15. The heating element of claim 6, wherein the circuit trace comprises at least a first set of diamonds having an electrical resistance and first shape and a second set of diamonds having said electrical resistance and a second shape different than the first shape and constituting less mass, the second set of diamonds running at a surface temperature higher than a surface temperature of the first set of diamonds when a voltage is applied to the circuit trace.

16. The heating element of claim 15, wherein a difference in shape is based on one of a strand width of the diamonds of the circuit trace, a width of the diamonds, a number of diamonds in a set, an internal width or height spacing between strands forming a diamond.

17. A method of making a heating element assembly having a three dimensional shape, comprising:
providing the heating element of claim 6 in a first shape or a heating element that does not have surface temperature difference capability in a first shape;
fastening portions of the heating element to one or more support plates, the one or more support plates having a shape different than the heating element, wherein fastening of the portions of the heating element to the one or more support plates forms the heating element assembly with the heating element having an assembled three dimensional shape as a result of the difference in shape.

18. A three dimensional heating element comprising:
at least one support plate;
at least one heater trace, the heater trace having at least first and second terminals, the heater trace having a shape different than a shape of the at least one support plate,
fasteners for connecting the at least first and second terminals to the at least one support plate, fastening of the heater trace to the at least support plate providing the heating element with a three dimensional shape as a result of the shape difference between the heater trace and at least one support plate.

19. The three dimensional heating element of claim 18, wherein the shape difference further comprises the heater trace having a length longer than a length of the at least one support plate.

20. The three dimensional heating element of claim 18, wherein a heater trace includes a pair of heater trace portions, the pair of heater trace portions connected at one end by a bus connection, each heater trace portion having a terminal at the other end thereof, the bus connection and terminals fastened to the at least one support plate.

21. The three dimensional heating element of claim 18, comprising at least two support plates, one end of the heater trace fastened to one of the at least two support plates and the other end of the heater trace fastened to the other of the at least two support plates, the at least two support plates fastened together to form the three dimensional heating element.

22. The three dimensional heating element of claim 21, further comprising a center support plate attached to the heater trace at a midpoint thereof, the center support plate also attached to the at least two support plates to further change a shape of the heater trace when the at least two support plates are fastened together.
